(19) United States
(12) Patent Application Publication
(10) Pub. No.: US 2003/0021929 A1
(43) Pub. Date: Jan. 30, 2003

(54) Antistatic fluororesin tube

(76) Inventors: Masahide Takahashi, Hamamatsu-shi (JP); Takesi Ohya, Fukuroi-shi (JP); Yuuzou Atsumi, Fukuroi-shi (JP); Yoshio Kimura, Kikuchi-gun (JP)

Correspondence Address: NIXON & VANDERHYE P.C., 8th Floor, 1100 North Glebe Road, Arlington, VA, 22201-4714, US

(21) Appl. No.: 10/176,655

(22) Filed: Jun. 24, 2002

(30) Foreign Application Priority Data
Jun. 22, 2001 (JP) P. 2001-190137

(51) Int. Cl. B32B 1/08

(52) U.S. Cl. 428/36.9

(57) ABSTRACT

An antistatic fluororesin tube includes conductive portions made of a thermofusible fluororesin composition containing a conductive material, and a transparent portion made of thermofusible fluororesin. Each of the conductive portions extends like a stripe in a longitudinal direction of a tube body, which is made of the transparent portion. The conductive portions are embedded in an outer circumferential surface of the tube body so as to be exposed partially, and a thickness of each of the conductive portions is not smaller than 0.01 mm and not larger than 20% of a thickness of the tube body.

### BACKGROUND OF THE INVENTION

1. Field of the Invention

The present invention relates to an antistatic fluororesin tube.

2. Description of the Related Art

Fluororesin tubes have been heretofore used for transportation of flammable fluid, corrosive fluid, high viscosity fluid and powder, or the like, because they are superior in chemical resistance, heat resistance, stain resistance and easiness to be bonded. However, fluororesin has a very high intrinsic volume resistivity which is not lower than 10¹⁸ Ω·cm. Therefore, the fluororesin tubes are charged easily due to friction when substances circulate through the tubes.

Accordingly, it can be considered that fluororesin mixed with a conductive material such as carbon black, iron powder or the like is molded into a tube so as to give conductivity to the fluororesin tube. However, since such a conductive material is black, the tube also becomes opaque. Thus, in a case where the tube is clogged with fluid, there occurs a problem that the clogged place is not known.

Against such a problem, for example, in Japanese Utility Model Laid-Open No. Hei. 1-96593, there is proposed a tube having a conductive portion made of a polytetrafluorethylene composition containing a conductive material, and a transparent portion made of only polytetrafluorethylene. These two portions extend in the longitudinal direction of the tube respectively. In Japanese Patent Laid-Open No. 2000-266247, there is proposed a fluororesin tube in which conductive portions shaped like stripes, made of a fluororesin composition mixed with a conductive material and each extending in the longitudinal direction of the tube, have been provided inside the thickened portion of a transparent fluororesin tube. In addition, there is also used a nylon or polyethylene tube containing carbon and cut spirally, or a transparent fluororesin tube around which a conductive member such as a stainless steel coil or the like is wound. Each of these antistatic fluororesin tubes has a conductive portion and a transparent fluororesin portion, and is designed so that the inside of the tube can be seen while the conductivity is given thereto.

However, in the antistatic fluororesin tube disclosed in Japanese Utility Model Laid-Open No. Hei. 1-96593, the conductive material is exposed in the inner wall so that there is a problem that passing substances passing through the tube are contaminated. In the antistatic resin tube disclosed in Japanese Patent Laid-Open No. 2000-266247, there is no fear that such passing substances are contaminated, but the antistatic performance is insufficient because the conductive portions are embedded in the thickened portion of the tube.

In addition, these antistatic fluororesin tubes are obtained by simultaneously extruding a molding material for a conductive portion, containing a conductive material, together with a molding material for a transparent portion, made of only fluororesin, and molding these two molding materials into a pipe-like shape. However, since the molding material for a conductive portion contains the conductive material, the thermal conductivity of the conductive portion molding material is higher so that the cooling rate is higher. Thus, when the molding is carried out, there occurs a phenomenon generally called “sinking”, in which the thickness of the transparent portion abutting against the conductive portion is reduced, or there appears deformation in the tube outer diameter or a difference in thickness due to the difference in degree of shrinkage between the conductive portion and the transparent portion at the time of cooling. Thus, there is a problem that it is difficult to mold a tube superior in dimensional accuracy. In the antistatic fluororesin tube disclosed in Japanese Utility Model Laid-Open No. Hei. 1-96593, the conductive portion and the transparent portion have the same thickness. On the other hand, also in the antistatic resin tube disclosed in Japanese Patent Laid-Open No. 2000-266247, the conductive portions are embedded to occupy a considerable percentage of the transparent portion. In both the cases, the conductive portions are formed to be so thick that sinking or deformation is apt to be conspicuous.

The deformation of the tube has a bad influence on the sealing properties with a joint so that passing substances become easy to leak. Particularly, when the passing substances are flammable fluid, flammable gas leaking out pervades the room. At this time, when the outer circumferential surface of the antistatic fluororesin tube is charged, and a worker touches the tube, sparks may be thrown to cause an explosion.

On the other hand, for producing the antistatic fluororesin tube designed to have a conductive member wound therearound, the work of complicated winding and fixing is required. Thus, there is a problem that the cost is increased considerably.

### SUMMARY OF THE INVENTION

The present invention was developed in consideration of the foregoing circumstances. An object of the present invention is to provide an antistatic fluororesin tube in which the dimensional accuracy is high, the sealing properties with a joint is so excellent that there occurs no leakage of passing substances, the outer circumferential surface of the tube is surely prevented from charging to thereby totally eliminate the risk of explosion even in an environment filled with flammable gas, and the tube is low in cost.

In order to attain the foregoing object, the present invention provides an antistatic fluororesin tube having conductive portions made of a thermofusible fluororesin composition containing a conductive material, and a transparent portion made of thermofusible fluororesin. The tube is characterized in that the conductive portions each extending like a stripe in a longitudinal direction of a tube body made of the transparent portion is embedded in an outer circumferential surface of the tube body so as to be exposed partially, and a thickness of each of the conductive portions is not smaller than 0.01 mm and not larger than 20% of a thickness of the tube body.

### BRIEF DESCRIPTION OF THE DRAWINGS

FIG. 1 is a sectional view showing an embodiment of an antistatic fluororesin tube according to the present invention.

FIG. 2 is a sectional view showing another embodiment of an antistatic fluororesin tube according to the present invention.

FIG. 3 is a sectional view showing an antistatic fluororesin tube used in Comparative Examples.

### DETAILED DESCRIPTION OF THE PREFERRED EMBODIMENTS

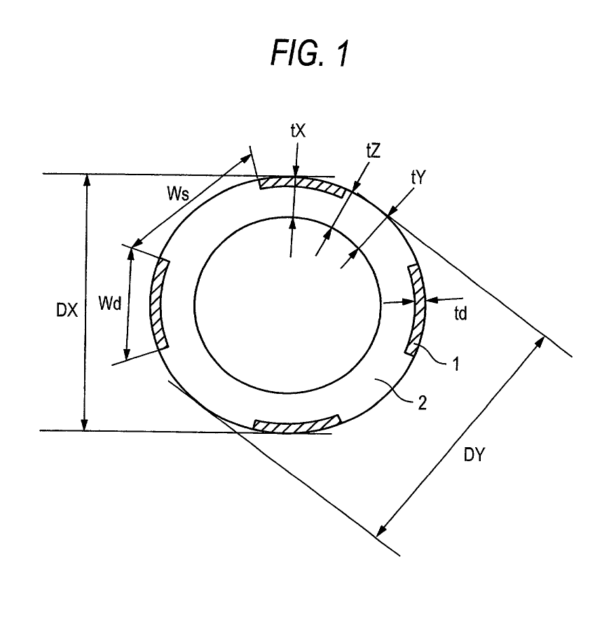

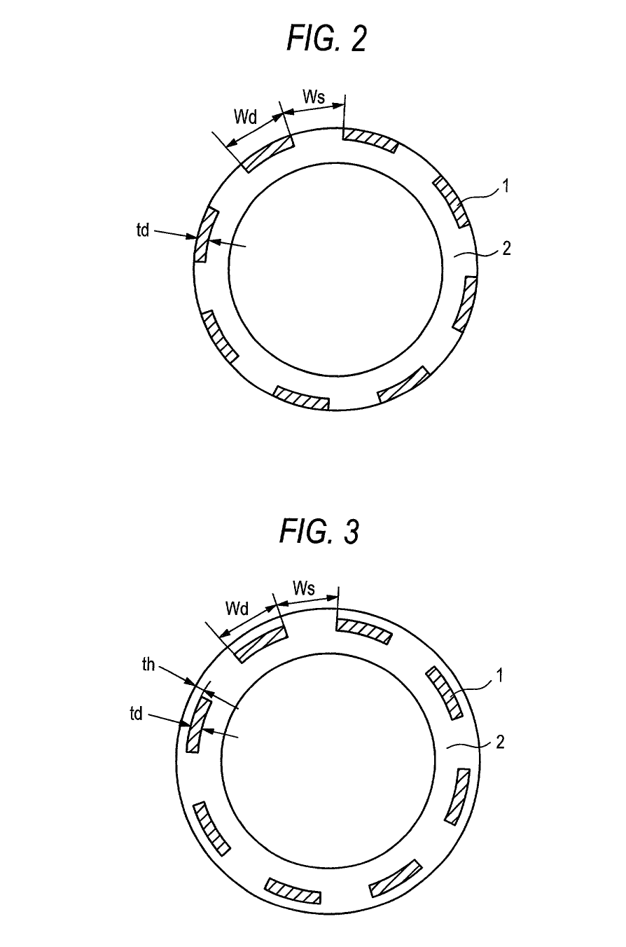

Detailed description will be made below about the present invention with reference to the drawings. FIG. 1 is a sectional view showing an embodiment of an antistatic fluororesin tube according to the present invention, and FIG. 2 is a sectional view showing another embodiment.

First, the configuration will be described. The antistatic fluororesin tube according to the present invention is constituted by conductive portions 1 made of a thermofusible composition containing a conductive material, and a transparent portion 2 made of thermofusible fluororesin. This transparent portion 2 forms a tube body of the antistatic fluororesin tube. On the other hand, each of the conductive portions 1 takes the shape of stripe extending in the longitudinal direction of the tube body. The conductive portions 1 are embedded in the transparent portion 2 and exposed partially so as to form the same surface as the outer circumferential surface of the transparent portion 2. The number of the conductive portions 1 is not limited particularly if the number of the conductive portions satisfies the interval (Ws) in a circumferential direction, which will be described later. For example, four conductive portions 1 may be provided at an equal interval as shown in FIG. 1, or eight conductive portions 1 may be provided at an equal interval as shown in FIG. 2. Here, in this antistatic tube, though not shown, a ground terminal made of metal or conductive resin is inserted into a suitable portion of the outer surface of the tube so as to be grounded.

Here, the thickness (td) of each of the conductive portions 1 is set to be not smaller than 0.01 mm, and not larger than 20% of the thickness (tX) of the tube body (transparent portion 2), preferably not larger than 10% thereof. When the thickness (td) of the conductive portion 1 is smaller than 0.01 mm, the conductive portion 1 may be cut off due to contact with the outside. This is undesirable from an antistatic aspect. On the contrary, when the thickness (td) of the conductive portion 1 exceeds 20% of the thickness (tZ) of the tube body, the difference in thermal conductivity and the difference in degree of shrinkage between the conductive portion 1 and the transparent portion 2 are so large that deformation or sinking is apt to occur in the tube.

In addition, the interval (Ws) between the conductive portions 1 in a circumferential direction is appropriately in a range of from 1 mm to 6 mm. When the interval (Ws) is wider than 6 mm, there is a fear that static electricity charged in the transparent portion 2 cannot be eliminated entirely. On the contrary, when the interval (Ws) is narrower than 1 mm, there is indeed an advantage in view of conductivity, but it becomes difficult to observe the inside of the tube.

The thickness (td) of the conductive portions 1 and the interval (Ws) between the conductive portions 1 are set suitably within their preferable ranges as above respectively in consideration of the diameter (DX) of the antistatic fluororesin tube, the use form thereof, and so on. In addition, the circumferential width (wd) of each of the conductive portions 1 is not limited particularly, but set suitably in accordance with the interval (Ws) and the number of the conductive portions 1.

In addition, in view of the antistatic performance of the tube as a whole, it is preferable that the intrinsic volume resistivity of the conductive portions 1 is not higher than 10⁸ Ω·cm. Although the compounding ratio of the conductive material varies in accordance with the kind of the conductive material, the conductive material is compounded and adjusted in a range of 5-20 wt % to the thermofusible fluororesin. Examples of such a conductive material include carbon black, carbon fiber, graphite, metal fine powder, etc. Each of these examples may be used singly, or two or more kinds of these examples may be used in combination. Incidentally, the intrinsic volume resistivity of the conductive portion 1 may be changed so that this conductive portion 1 can be used as a low-voltage logical signal line of not higher than 24 V by way of example.

On the other hand, as for the thermofusible fluororesin, any fluororesin can be used if it can be molded by melt extrusion and has light transmission properties. Examples of such fluororesins include tetrafluoroethylene-perfluoroalkyl vinyl ether copolymer (PFA), tetrafluoroethylene-hexafluoropropylene copolymer (FEP), tetrafluoroethylene-hexafluoropropylene-vinylidene fluoride terpolymer, etc. Incidentally, although the thermofusible fluororesin used for the conductive portions 1 may be different in kind from the thermofusible fluororesin used for the transparent portion 2, it is preferable that one and the same kind of thermofusible fluororesin is used to enhance the integration of these two kinds of portions.

Such an antistatic fluororesin tube in which each of the conductive portions 1 shaped like a stripe is exposed in the longitudinal direction of the outer circumferential surface can be obtained by use of two extruders. First, a thermofusible fluororesin composition containing a conductive material is melted and kneaded in one of the extruders, and extruded like stripes by the extruder. The extruded pieces are introduced into a dice of the other extruder, and next extruded together with thermofusible fluororesin by this other extruder. The extruded product is cooled and solidified by a sizing die. In addition, not to say, it becomes easy to connect the conductive portions 1 to the ground at the time of earthing because the conductive portions 1 are exposed.

### EXAMPLES

The present invention will be described further along its examples and comparative examples. Incidentally, the present invention is not limited to this description at all.

### Example 1

Pellets of PFA containing 8 wt % of carbon black were used as the thermofusible fluororesin composition containing a conductive material, while pellets of PFA were used as the thermofusible fluororesin. By use of these pellets as raw materials, extrusion molding (molding temperature 370° C.) was carried out with two extruders in the following manner. The carbon black-containing PFA pellets were melted and kneaded in one of the extruders, and extruded like four stripes by a dice. The extruded pieces were introduced into a dice of the other extruder and extruded together with the PFA pellets. The extruded product was cooled and solidified in a sizing die. Thus, a test tube measuring about 6.35 mm in outer diameter and about 1.0 mm in thickness and having a sectional shape shown in FIG. 1 was obtained.

### Examples 2 to 8, and Comparative Examples 1 to 5

In addition, according to Example 1, the discharge rates of the extruders were adjusted to vary the thickness of the conductive portions. Thus, similar test tubes were obtained.

### Comparative Example 6

Further, a test tube made of only PFA was obtained by use of one extruder and in the same conditions.

Measurement of dimensions of respective portions, measurement of charge potential and examination of sealing with a joint were carried out on each test tube. The results are shown in Table 1. Incidentally, the intrinsic volume resistivity of conductive portions was 600-700 Ω·cm in each of the test tubes in Examples 1 to 8 and Comparative Examples 1 to 5. On the other hand, the intrinsic volume resistivity of conductive portions in the PFA tube in Comparative Example 6 was not lower than 10¹⁸ Ω·cm.

The charge potential was measured in the following manner. That is, one end of each test tube, which is 1 m long, was connected to the ground, and destaticized by a static eliminator (KP-410 made by Kasuga Electric Works Ltd.). Then, a 20 cm-long central portion of the test tube was rubbed with cloth 50 times, and the potential of the rubbed portion was measured by an electrostatic meter (KSD-9202 made by Kasuga Electric Works Ltd.).

In addition, two kinds of tests were carried out as the examination of sealing with a joint. First, in Sealing Test 1, each test tube was joined to a metal joint (F900-P-9.52 made by Fujikin Incorporated) having an outer diameter of 9.52 mm, and put into a water tank (25° C.). N₂ gas was introduced into the test tube, and the pressure with which leakage occurred was observed. Incidentally, the N₂ gas was kept in each pressure for 15 minutes, and the pressure thereof was increased up to 16 kg/cm²G by 2 kg/cm²G every time. In addition, Sealing Test 2 was carried out as follows. That is, a sample in which the same joint and the test tube were joined was heated at 100° C. for 24 hours in an electric furnace. After the sample was cooled, pressure was applied thereto similarly.

TABLE 1

| | Thickness | | | | | | |
|---|---|---|---|---|---|---|---|
| | Ratio of | Thickness of | Interval | Thickness of | Thickness of | Thickness | |
| | Conductive | Conductive | between | Conductive | Transparent | of Border | |
| | Portion | Portion | Stripes | Portion of | Portion of | Portion of | tX-tY |
| | (%) | td (mm) | Ws (mm) | Tube tX (mm) | Tube tY (mm) | Tube tZ (mm) | (mm) |
| Example 1 | 1.0 | 0.01 | 3.49 | 1.00 | 1.00 | 1.00 | 0 |
| Example 2 | 3.0 | 0.03 | 3.49 | 1.01 | 1.01 | 1.01 | 0 |
| Example 3 | 5.9 | 0.06 | 3.58 | 1.01 | 1.01 | 1.01 | 0 |
| Example 4 | 8.0 | 0.08 | 3.59 | 1.00 | 1.00 | 0.99 | 0 |
| Example 5 | 10.0 | 0.10 | 3.62 | 1.00 | 1.00 | 0.99 | 0 |
| Example 6 | 13.1 | 0.13 | 3.63 | 0.99 | 0.99 | 0.97 | 0 |
| Example 7 | 16.8 | 0.17 | 3.63 | 1.01 | 1.00 | 0.98 | 0.01 |
| Example 8 | 20.0 | 0.20 | 3.65 | 1.00 | 0.99 | 0.96 | 0.01 |
| Comparative | 22.5 | 0.23 | 3.63 | 1.02 | 1.00 | 0.96 | 0.02 |
| Example 1 | | | | | | | |
| Comparative | 30.4 | 0.31 | 3.67 | 1.02 | 0.98 | 0.94 | 0.04 |
| Example 2 | | | | | | | |
| Comparative | 36.3 | 0.37 | 3.65 | 1.02 | 0.97 | 0.92 | 0.05 |
| Example 3 | | | | | | | |
| Comparative | 45.6 | 0.47 | 3.68 | 1.03 | 0.96 | 0.92 | 0.07 |
| Example 4 | | | | | | | |
| Comparative | 52.9 | 0.55 | 3.66 | 1.04 | 0.96 | 0.91 | 0.08 |
| Example 5 | | | | | | | |
| Comparative | | | | | | | |
| Example 6 | 0 | — | — | — | 1.00 | — | — |
| (PFA tube) | | | | | | | |

| | | Outer | Outer | | | Sealing Test 1 | Sealing Test 2 |
|---|---|---|---|---|---|---|---|
| | | Diameter of | Diameter of | | | (Leakage | (Leakage |
| | | Conductive | Transport | | Charge | Occurence | Occurence |
| | tX-tZ | Portion of | Portion of | DX-DY | Potential | pressure) | Pressure |
| | (mm) | Tube DX (mm) | Tube DY (mm) | (mm) | (kV) | (kg/cm²) | (kg/cm²) |
| Example 1 | 0 | 6.36 | 6.35 | 0.01 | 0.5-0.6 | No | No |
| | | | | | | Leakage | Leakage |
| Example 2 | 0 | 6.36 | 6.33 | 0.03 | 0.5-0.6 | No | No |
| | | | | | | Leakage | Leakage |
| Example 3 | 0 | 6.37 | 6.31 | 0.06 | 0.5-0.6 | No | No |
| | | | | | | Leakage | Leakage |
| Example 4 | 0.01 | 6.37 | 6.30 | 0.07 | 0.5-0.6 | No | No |
| | | | | | | Leakage | Leakage |
| Example 5 | 0.01 | 6.39 | 6.30 | 0.09 | 0.5-0.6 | No | No |
| | | | | | | Leakage | Leakage |
| Example 6 | 0.02 | 6.39 | 6.28 | 0.11 | 0.5-0.6 | No | 14 |
| | | | | | | Leakage | |
| Example 7 | 0.03 | 6.39 | 6.27 | 0.12 | 0.5-0.6 | No | 12 |
| | | | | | | Leakage | |
| Example 8 | 0.04 | 6.42 | 6.30 | 0.12 | 0.5-0.6 | No | 10 |
| | | | | | | Leakage | |
| Comparative | 0.06 | 6.42 | 6.27 | 0.15 | 0.5-0.6 | 12 | 4 |
| Example 1 | | | | | | | |
| Comparative | 0.08 | 6.42 | 6.25 | 0.21 | 0.5-0.6 | 10 | 2 |
| Example 2 | | | | | | | |
| Comparative | 0.10 | 6.42 | 6.20 | 0.26 | 0.5-0.6 | 6 | 2 |
| Example 3 | | | | | | | |
| Comparative | 0.11 | 6.50 | 6.19 | 0.31 | 0.5-0.6 | 4 | 2 |
| Example 4 | | | | | | | |
| Comparative | 0.13 | 6.50 | 6.14 | 0.36 | 0.5-0.6 | 4 | 2 |
| Example 5 | | | | | | | |
| Comparative | — | — | 6.35 | — | 4.0-5.2 | No | No |
| Example 6 | | | | | | Leakage | Leakage |
| (PFA tube) | | | | | | | |

As is apparent from Table 1, when the thickness ratio of the conductive portion [conductive portion thickness (td)/tube thickness (tX) including conductive portions] is not higher than 20% (providing that the conductive portion thickness (td) is not smaller than 0.01 mm), the dimensional accuracy (DX-DY) is so high that there occurs no leakage in Sealing Test 1 at room temperature. Particularly, when the thickness ratio of the conductive portion is not higher than 10%, the dimensional accuracy is further improved so that there occurs no leakage even in Sealing Test 2 after heating at 100° C. Further, in each case, the charge potential is improved on a large scale in comparison with that in the PFA tube.

### Examples 9 to 15 and Comparative Examples 7 and 8

Test tubes each having a different distance (Ws) between conductive portions, measuring 25.4 mm in outer diameter, 22.22 mm in inner diameter and 1.59 mm in thickness and having a section formed as shown in FIG. 1 or 2 were obtained in the same manner as in Example 1, except that a dice was exchanged and the width (Wd) and the number of the conductive portions were varied. In addition, for the sake of comparison, a test tube made of only PFA was obtained by use of one extruder (Comparative Example 7). Further, for the sake of comparison, a test tube in which eight conductive portions 1 were embedded at an equal interval inside the thickness of a transparent portion 2 as shown in FIG. 3 was obtained in the same manner, except that a dice was exchanged (Comparative Example 8).

Charge potentials of the respective test tubes obtained thus were measured in the same method as in Example 1. The results are shown in Table 2. Incidentally, the intrinsic volume resistivity of the conductive portions was 600-700 Ω·cm in each test tube.

TABLE 2

| | Interval of | Number of | Width of | Thickness of | Thickness of | |
|---|---|---|---|---|---|---|
| | Conductive | Conductive | Conductive | Conductive | Surface | Charge |
| | Portion | Portions | Portion | Portion | Layer PFA | Potential |
| | Ws (mm) | (Piece) | Wd (mm) | td (mm) | th (mm) | (KV) |
| Example 9 | 1.0 | 8 | 9.0 | 0.09 | — | 0.1-0.2 |
| Example 10 | 4.2 | 8 | 5.8 | 0.09 | — | 0.6-0.7 |
| Example 11 | 6.0 | 8 | 4.0 | 0.09 | — | 0.9-1.0 |
| Example 12 | 7.7 | 8 | 2.3 | 0.09 | — | 1.2-1.3 |
| Example 13 | 10.9 | 4 | 9.0 | 0.09 | — | 1.8-2.0 |
| Example 14 | 14.1 | 4 | 5.8 | 0.09 | — | 2.3-2.5 |
| Example 15 | 17.9 | 4 | 2.3 | 0.09 | — | 3.0-3.2 |
| Comparative | — | — | — | — | — | 13.3-13.7 |
| Example 7 | | | | | | |
| (PFA tube) | | | | | | |
| Comparative | 4.2 | 8 | 5.8 | 0.09 | 0.01 | 8.7-9.1 |
| Example 8 | | | | | | |
| (with | | | | | | |
| stripes | | | | | | |
| inside) | | | | | | |

As is apparent from Table 2, the charge potential is not higher than 1.0 KV when the interval (Ws) of the conductive portions is 1.0-6.0 mm. It is proved that the charge potential is improved on a large scale in comparison with the PFA tube, and very excellent antistatic performance is provided. In addition, in Comparative Example 8 in which conductive portions are embedded, the lowering of the charge potential is less, and it is proved that the antistatic effect is not sufficient.

As described above, in the antistatic fluororesin tube according to the present invention, each conductive portion shaped like a stripe is formed to be exposed in the longitudinal direction of the outer circumferential surface of the tube. The thickness of the conductive portion is made not smaller than 0.01 mm, and not larger than 20% of the tube thickness, more preferably not larger than 10% of the tube thickness. Accordingly, the tube is superior in sealing properties with a joint, and also superior in antistatic performance particularly in the outer circumferential surface of the tube. In addition, when the interval of the conductive portions is made not larger than 6 mm, particularly superior antistatic performance in the outer circumferential surface of the tube can be obtained. When the interval between the conductive portions is made not smaller than 1 mm, fluid inside the tube can be confirmed.

Accordingly, the antistatic fluororesin tube according to the present invention can be used effectively particularly in the field of semiconductors dealing with flammable fluid, where sealing properties and antistatic performance are especially important in view of security.

What is claimed is:

1. An antistatic fluororesin tube comprising:
a tube body including a transparent portion made of thermofusible fluororesin; and
conductive portions made of a thermofusible fluororesin composition containing a conductive material,
wherein each of said conductive portions extends like a stripe in a longitudinal direction of said tube body and is embedded in an outer circumferential surface of said tube body so as to be exposed partially, and
wherein a thickness of each of said conductive portions is not smaller than 0.01 mm and not larger than 20% of a thickness of said tube body.

2. The antistatic fluororesin tube according to claim 1, wherein the thickness of each of said conductive portions is not larger than 10% of said thickness of said tube body.

3. The antistatic fluororesin tube according to claim 1, wherein an interval between adjacent ones of said conductive portions in a circumferential direction is in a range of 1-6 mm.

4. The antistatic fluororesin tube according to claim 2, wherein an interval between adjacent ones of said conductive portions in a circumferential direction is in a range of 1-6 mm.

5. The antistatic fluororesin tube according to claim 1, wherein said transparent portion contains the same kind of thermofusible fluororesin as that of said conductive portions.

6. The antistatic fluororesin tube according to claim 2, wherein said transparent portion contains the same kind of thermofusible fluororesin as that of said conductive portions.

7. The antistatic fluororesin tube according to claim 3, wherein said transparent portion contains the same kind of thermofusible fluororesin as that of said conductive portions.
